(19) United States
(12) Patent Application Publication
(10) Pub. No.: US 2014/0122527 A1
(43) Pub. Date: May 1, 2014

(54) SENSITIVITY RETRIEVAL APPARATUS, METHOD AND PROGRAM

(71) Applicant: KABUSHIKI KAISHA TOSHIBA, Tokyo (JP)

(72) Inventor: Yumi ICHIMURA, Abiko-shi (JP)

(73) Assignee: KABUSHIKI KAISHA TOSHIBA, Tokyo (JP)

(21) Appl. No.: 14/067,253

(22) Filed: Oct. 30, 2013

(30) Foreign Application Priority Data
Oct. 30, 2012 (JP) 2012-238848

(51) Int. Cl. G06F 17/30

(52) U.S. Cl. CPC G06F 17/30979
USPC 707/769

(57) ABSTRACT

According to one embodiment, a sensitivity retrieval apparatus includes a storage, a receiving unit, a setting unit, a retrieval unit, an analysis unit and a presentation unit. The storage stores sensitivity expressions. The receiving unit receives a retrieval request sentence to retrieve. The setting unit sets an evaluation axis for a sensitivity word if the sensitivity word which is a part of the sensitivity expressions and which is included in the retrieval request sentence. The retrieval unit performs retrieval based on the retrieval request sentence. The analysis unit calculates analysis values for the requested content items based on the evaluation axis. The presentation unit presents at least one requested content item.

### CROSS-REFERENCE TO RELATED APPLICATIONS

This application is based upon and claims the benefit of priority from Japanese Patent Application No. 2012-238848, filed Oct. 30, 2012, the entire contents of which are incorporated herein by reference.

### FIELD

Embodiments described herein relate generally to a sensitivity retrieval apparatus, method and program.

### BACKGROUND

There exists a method of retrieving content via a computer network, in which the user need only input some keywords to retrieve the content he or she wants. In order to retrieve a food recipe, for example, the user may input the name, ingredients, grouping, etc., of the dish at a terminal apparatus. In this case, the recipe of the dish identified with the data items the user has input is displayed. However, the recipe so displayed is not always agreeable to the user's taste.

In view of this, a technique has been developed, which customizes the receipt to the user's taste. In this method, the taste (i.e., sweetness, hotness, etc.), texture (i.e., toughness, stickiness, etc.) and nutrient components of the food (i.e., vitamin, calcium, etc.) are displayed, before presenting the recipe of the food. The user may change the taste, texture and nutrient components to his liking and also change the amounts of ingredients to use. The recipe is thereby customized to the user's taste. Another technique has been developed, which performs sensitivity analysis on the evaluation of restaurants or on the foods served in each restaurant, using the food evaluation axes available in word-of-mouth communication.

### BRIEF DESCRIPTION OF THE DRAWINGS

FIG. 1 is a diagram illustrating a sensitivity retrieval system according to an embodiment;

FIG. 2 is a flowchart illustrating how a request analysis unit performs its function;

FIG. 3 is a diagram illustrating a table the request analysis unit uses an estimation rule;

FIG. 4 is another flowchart illustrating how an evaluation-axis setting unit performs its function;

FIG. 5 is a diagram illustrating an example of the expression table stored in an expression storage;

FIG. 6A is a flowchart illustrating how a result analysis unit performs its function;

FIG. 6B is another flowchart illustrating how the result analysis unit performs its function;

FIG. 7 is a diagram illustrating a first example of a table storing the values obtained in the request analysis unit;

FIG. 8 is a diagram illustrating a first example of a table storing the other values obtained in the request analysis unit;

FIG. 9 is a diagram illustrating a first example of a table storing the retrieval result obtained in a text retrieval unit;

FIG. 10 is a diagram illustrating an example of a table storing the values obtained by analyzing the evaluation axis of content;

FIG. 11 is a diagram illustrating an example of a table storing the other values obtained by analyzing the evaluation axis of content;

FIG. 12 is a diagram illustrating a first example of the analysis result displayed by a result presentation unit;

FIG. 13 is a diagram illustrating a second example of the analysis result;

FIG. 14 is a diagram illustrating a third example of the analysis result;

FIG. 15 is a diagram illustrating a fourth example of the analysis result;

FIG. 16 is a diagram illustrating a fifth example of the analysis result;

FIG. 17 is a diagram illustrating an example of the analysis result displayed in detail at the result presentation unit;

FIG. 18 is a diagram illustrating a second example of the table storing the values obtained in the request analysis unit;

FIG. 19 is a diagram illustrating a second example of the table storing the values obtained in the evaluation-axis setting unit;

FIG. 20 is a diagram illustrating a second example of the retrieval result obtained in the text retrieval unit;

FIG. 21 is a diagram illustrating a sixth example of the analysis result;

FIG. 22 is a diagram illustrating a region of the display screen displayed in a magnified form;

FIG. 23 is a diagram illustrating an example of the analysis result displayed in a magnified form;

FIG. 24 is a diagram illustrating another example of the analysis result displayed in a magnified form; and

FIG. 25 is a diagram illustrating an example of the analysis result list displayed by the result presentation unit.

### DETAILED DESCRIPTION

The techniques described above are not designed on the assumption that data is retrieved in accordance with keywords representing sensitivity, such as “healthy muffin” or “sticky needle,” which means different things because the sense of values differs from person to person. Consequently, the retrieval result obtained in the methods is not desirable to the user.

In general, according to one embodiment, a sensitivity retrieval apparatus includes a storage, a receiving unit, a setting unit, a retrieval unit, an analysis unit and a presentation unit. The storage is configured to store sensitivity expressions which are words representing sensitivity. The receiving unit is configured to receive a retrieval request sentence which is a character string to retrieve. The setting unit is configured to set an evaluation axis for a sensitivity word if the sensitivity word which is a part of the sensitivity expressions and which is included in the retrieval request sentence. The retrieval unit is configured to perform retrieval based on the retrieval request sentence, to obtain a plurality of requested content items. The analysis unit is configured to calculate analysis values for the requested content items based on the evaluation axis. The presentation unit is configured to present at least one requested content item based on the analysis values.

In the subsequent, a sensitivity retrieval apparatus, method and program, according to the present embodiments will be described in details with reference to the drawings. In the embodiments described below, elements specified by the same reference number carry out the same operation, and a repetitive description of such elements will be omitted.

### First Embodiment

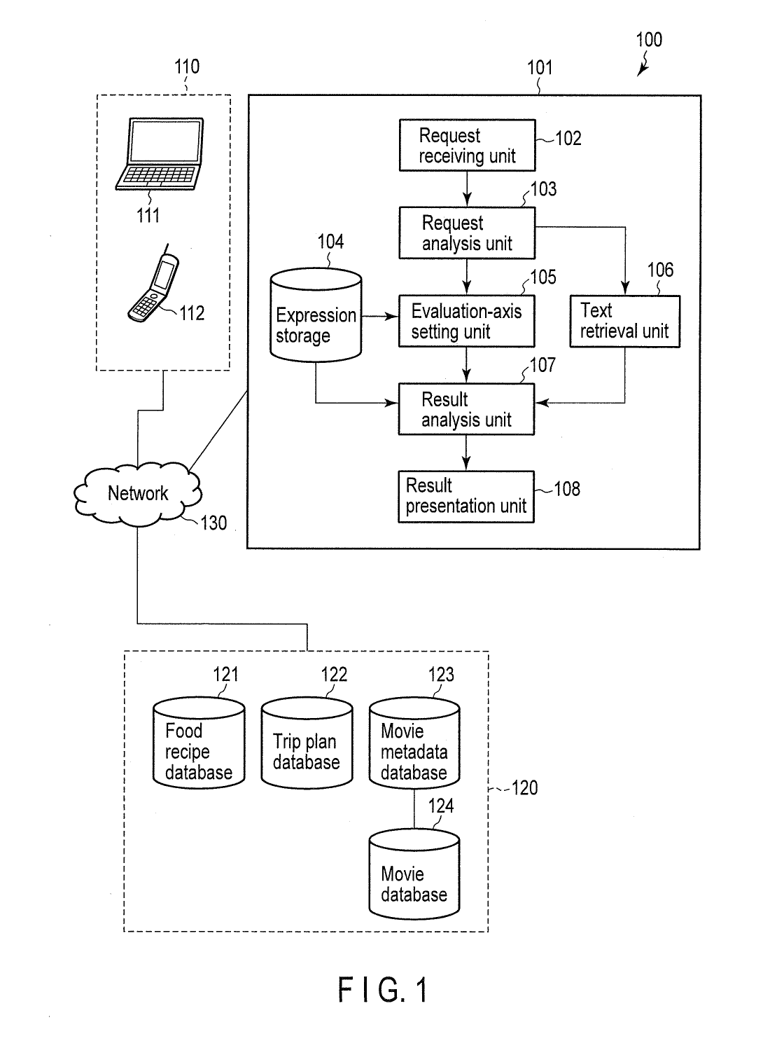

A sensitivity retrieval system according to this embodiment will be described with reference to the block diagram of FIG. 1.

The sensitivity retrieval system 100 includes a sensitivity retrieval apparatus 101 (also called sensitivity retrieval server), a user terminal 110, and a storage apparatus 120.

The user terminal 110 is a mobile terminal such as a personal computer (PC) 111 or a mobile telephone 112. The user terminal 110 is connected to the sensitivity retrieval apparatus 101 via a network 130 such as the Internet or the mobile telephone network, and transmits, to the sensitivity retrieval apparatus 101, a retrieval request sentence indicating a character string that the user has input to retrieve keywords, etc. The user terminal 110 receives the retrieval result that the sensitivity retrieval apparatus 101 has transmitted in response to the retrieval request sentence. The user terminal 110 then displays the retrieval result on its display screen.

The storage apparatus 120 is a database storing information about content. In this embodiment, the storage apparatus 120 includes a food recipe database 121, a trip plan database 122, a movie metadata database 123, and a movie database 124. The food recipe database 121, trip plan database 122 and movie metadata database 123 store text data about the respective types of content. The movie metadata database 123 is associated with the movie database 124 that stores video data corresponding to the metadata.

The storage apparatus 120 may include other databases storing content about other genres such as sports and music. Further, the food recipe database 121 and the trip plan database 122 may be associated with video data databases (not shown) storing video data about food preparing sequences and video data about trip plans.

The sensitivity retrieval apparatus 101 receives a retrieval request sentence from the user terminal 110, and extracts text data from the storage apparatus 120 in response to the retrieval request sentence. Then, the sensitivity retrieval apparatus 101 generates an analysis result from the text data and transmits the analysis result to the user terminal 110.

The user terminal 110 may have the function or program of the sensitivity retrieval apparatus 101, not given via the network 130. Further, the user terminal 110 may incorporates the storage apparatus 120.

The sensitivity retrieval apparatus 101 will be described in detail, with reference to the block diagram of FIG. 1.

The sensitivity retrieval apparatus 101 includes a request receiving unit 102, a request analysis unit 103, an expression storage 104, an evaluation-axis setting unit 105, a text retrieval unit 106, a result analysis unit 107, and a result presentation unit 108.

The request receiving unit 102 receives a retrieval request sentence from the user terminal 110 or the user.

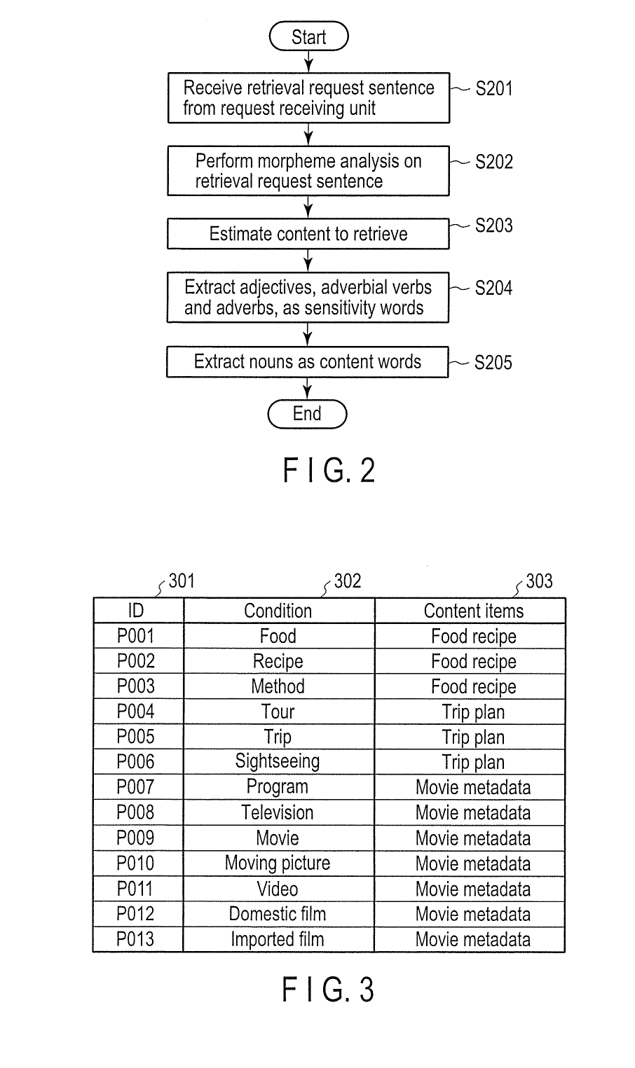

The request analysis unit 103 receives the retrieval request sentence from the request receiving unit 102. From the retrieval request sentence, the request analysis unit 103 infers the content to retrieve. The request analysis unit 103 then extracts a sensitivity word and a content word. The sensitivity word is an adjective, an adjectival verb or an adverb, and is included in a sensitivity expression, which will be described later. The content word is a noun included in the retrieval request sentence. How the request analysis unit 103 operates will be described later, with reference to FIG. 2.

The expression storage 104 stores an expression table including sensitivity expressions, content expressions and evaluation polarities. The sensitivity expressions are words representing human's sensitivity. The content expressions are words representing an element of the sensitivity expressions. The evaluation polarities are indexes representing the relationship between the sensitivity expressions and the content expressions. The expression table stored in the expression storage 104 will be described later with reference to FIG. 5.

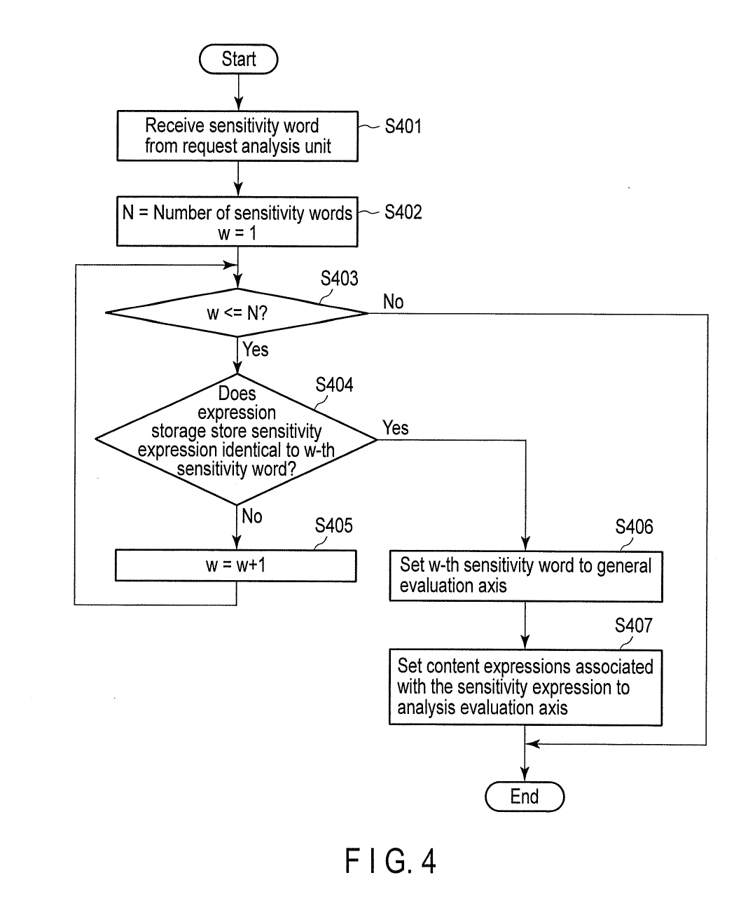

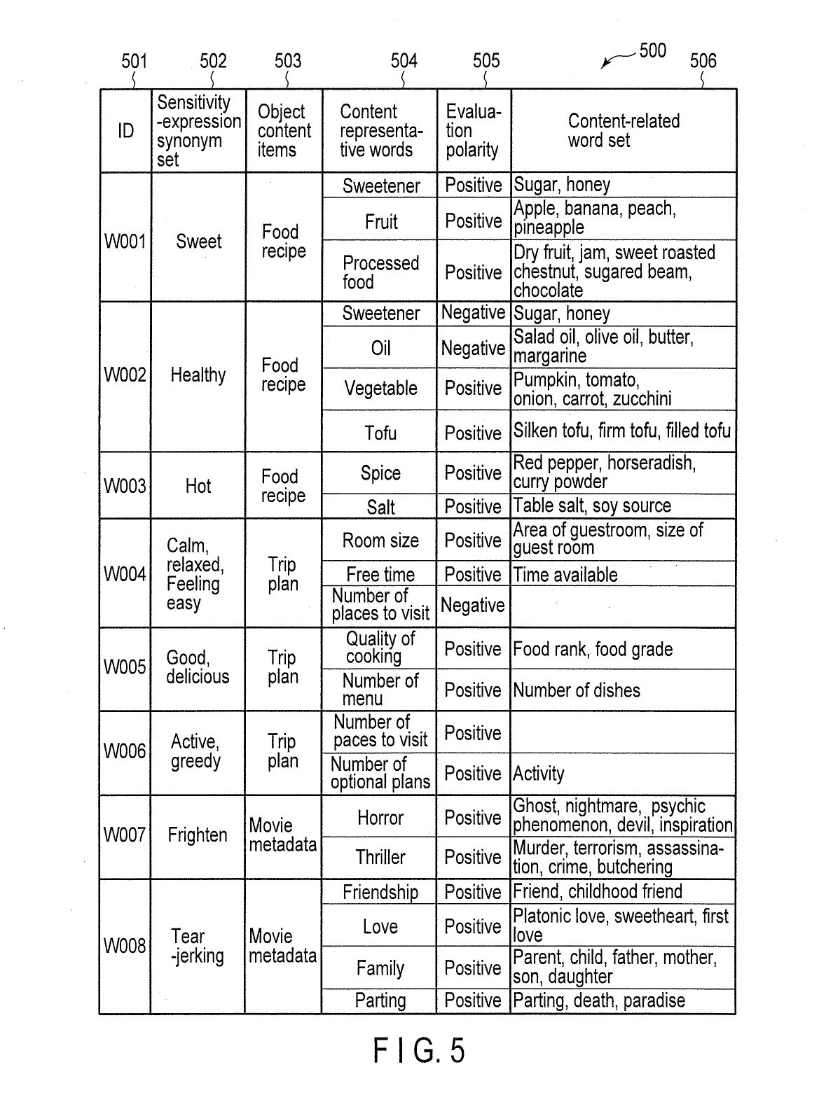

The evaluation-axis setting unit 105 receives a sensitivity word from the request analysis unit 103, refers to the expression storage 104, and sets the sensitivity expression identical to the sensitivity word, as an evaluation axis. How the evaluation-axis setting unit 105 operates will be explained later in detail, with reference to FIG. 4.

The text retrieval unit 106 receives a content word from the request analysis unit 103 and extracts one or more content items related to the content to retrieve, from that data base stored in the storage apparatus 120, which includes this content. One or more extracted content items are also referred to as requested content items.

The result analysis unit 107 receives the evaluation axis from the evaluation-axis setting unit 105 and also one or more content items from the text retrieval unit 106. Then, the result analysis unit 107 calculates, referring to the expression table stored in the expression storage 104, analysis values of one or more content items for each evaluation axis, obtaining an analysis result. The result presentation unit 108 receives the analysis result from the result analysis unit 107, and displays the analysis result. The analysis result may be displayed at, for example, the display of the user terminal 110. An operation of the request analysis unit 103 will be explained with reference to the flowchart of FIG. 2.

In Step S201, the request analysis unit 103 receives a retrieval request sentence from the request receiving unit 102.

In Step S202, the request analysis unit 103 performs a morpheme analysis on the retrieval request sentence. The morpheme analysis is a process of ordinary type, and is not explained here.

In Step S203, the request analysis unit 103 estimates the content to retrieve, on the basis of the words included in the retrieval request sentence subjected to the morpheme analysis.

In Step S204, the request analysis unit 103 extracts sensitivity words, such as adjectives, adverbial verbs and adverbs, from the retrieval request sentence subjected to the morpheme analysis.

In Step S205, the request analysis unit 103 extracts the nouns, as content words, from the retrieval request sentence subjected to the morpheme analysis.

The content, sensitivity words and content word, so acquired in the process described above and to be retrieved may be written in a buffer and held therein. For example, a data storage (not shown) may be provided in the sensitivity retrieval apparatus 101, and may hold the data. Then, the request analysis unit 103 terminates its operation.

An estimation process of the request analysis unit 103 in Step S203 will be explained with reference to FIG. 3.

FIG. 3 is a diagram showing a table showing an example of the rule the request analysis unit 103 accords to draw inferences. In the table, identifiers (ID) 301 are associated various conditions and various content items 303. For example, ID301 “P001” is associated with condition “food” and content item 303 “food recipe” in the table.

Assume that the retrieval request sentence subjected to the morpheme analysis includes the word “food.” Then, the request analysis unit 103 can infer that the content to retrieve is “food recipe,” because the content item 303 associated with the condition 302 “food” is “food recipe” in the estimation rule of FIG. 3.

In this embodiment, any content that should be retrieved is estimated in accordance with whether or not a word is listed in the estimation rule. Nonetheless, the content may be estimated on the basis of two or more words related to one another. Further, a syntactical dependency analysis may be performed to extract the relation between words, thereby to estimate the content to retrieve. Still further, the estimation-rule table may be held in the request analysis unit 103 or may be stored in the expression storage 104 or in the data storage unit (not shown) mentioned above.

An operation of the evaluation-axis setting unit 105 will be explained with reference to the flowchart of FIG. 4.

In Step S401, the evaluation-axis setting unit 105 receives a sensitivity word from the request analysis unit 103.

In Step S402, the evaluation-axis setting unit 105 sets variables N and w, respectively representing the number of sensitivity words and the initial counter value, to initial value 1.

In Step S403, it is determined whether or not variable w is not more than variable N. If variable w is not more than variable N, the process goes to Step S404. If variable w is greater than variable N, the evaluation-axis setting unit 105 terminates its operation.

In Step S404, it determined whether or not the expression storage 104 stores a sensitivity expression identical to the w-th sensitivity word. If the expression storage 104 stores a sensitivity expression identical to the w-th sensitivity word, the process goes to Step S407. If the expression storage 104 does not store a sensitivity expression identical to the w-th sensitivity word, the process goes to Step S405.

In Step S405, variable w is incremented by one. The process then returns to Step S403, which is repeated. In Step S406, the w-th sensitivity word is set to a general evaluation axis. If two or more sensitivity words have been input, the sensitivity word first found included in the sensitivity expression stored in the expression storage 104 may be set to the general evaluation axis, or all sensitivity words may be set to the general evaluation axis. The importance of any sensitivity word may be calculated from the result of the syntactical dependency analysis of the retrieval request sentence, and only the sensitivity word found most important may be set to the general evaluation axis.

In Step S407, a plurality of content expressions associated with the sensitivity expression that is identical to the sensitivity word set to the general evaluation axis in Step S406 are set to analysis evaluation axes. The general evaluation axis obtained in Step S406 and the analysis evaluation axes obtained in Steps S407 may be written in a buffer (for example, data storage unit [not shown]) and may be stored therein. Then, the evaluation-axis setting unit 105 terminates its operation.

An example of the expression table stored in the expression storage 104 will be described with reference to FIG. 5.

In the expression table 500 shown in FIG. 5, IDs 501, sensitivity-expression synonym sets 502, object content items 503, content representative words 504, evaluation polarities 505, and content-related word sets 506. Each ID 501 is associated with a synonym set 502, an object content item 503, a content representative word 504, an evaluation polarity 505, and a content-related word set 506.

Each ID 501 is an identifiers uniquely allocated in the expression storage 104. Each sensitivity-expression synonym set 502 is a group of sensitivity synonyms. Each object content item 503 is identical to one content item 303 shown in FIG. 3. Each content representative word 504 is a word which may be related to one sensitivity-expression synonym set 502 and which represents a highest conception of any word of the associated content-related word set 506. For example, the sensitivity expression “healthy” is associated with “sweetener,” “oil” and “vegetable,” because the amounts in which to use these items are very important. The words “sweetener,” “oil” and “vegetable” are therefore used as content representative words 504. Each evaluation polarity 505 indicates how an increase or decrease of the index value of one content representative word 504 influences the general evaluation axis, and is represented by either “positive” or “negative.” Thus, the sweetener associated with ID501 “W001,” for example, has evaluation polarity 505, “positive,” because the food is sweet in proportion the amount of the sweetener used, on the general evaluation axis of “sweetness.” On the other hand, the sweetener associated with ID501 “W002,” for example, has evaluation polarity 505, “negative,” because the food is more healthy in inverse proportion the amount of the sweetener used, on the general evaluation axis of “healthy.”

Each content-related word set 506 consists of several specific words all falling within the category of the associated content representative word 504. That is, the content-related word set 506 specifies items that the content representative word 504 generally expresses. If no words fall within the category of the associated content representative word 504, the content-related word set 506 will be blank in the expression table 500.

More specifically, the content representative word 504, “spice,” evaluation polarity 505, “negative,” and content-related word set 506, “red pepper, horseradish, curry powder,” are associated with the sensitivity-expression synonym set 502 “hot,” and the object content item 503, “food recipe.” Similarly, the content representative word 504, “salt,” evaluation polarity 505, “positive,” and content-related word set 506, “table salt and soy source” are associated with a sensitivity-expression synonym set 502 and an object content item 503.

If the evaluation-axis setting unit 105 determines that a sensitivity word is identical to any expression included in sensitivity-expression synonym set 502, the sensitivity word is set to the general evaluation axis, and the expression associated with the sensitivity word and included in the content representative word 504 is set to the analysis evaluation axis. To be more specific, if the sensitivity word is “healthy,” it is set as the general evaluation axis because the word “healthy” is identical to both ID501, “W002,” and to sensitivity-expression synonym set 502, “healthy.” Further, four content representative words 504, “sweetener,” “oil,” “vegetable” and “tofu,” are set as the analysis evaluate axis.

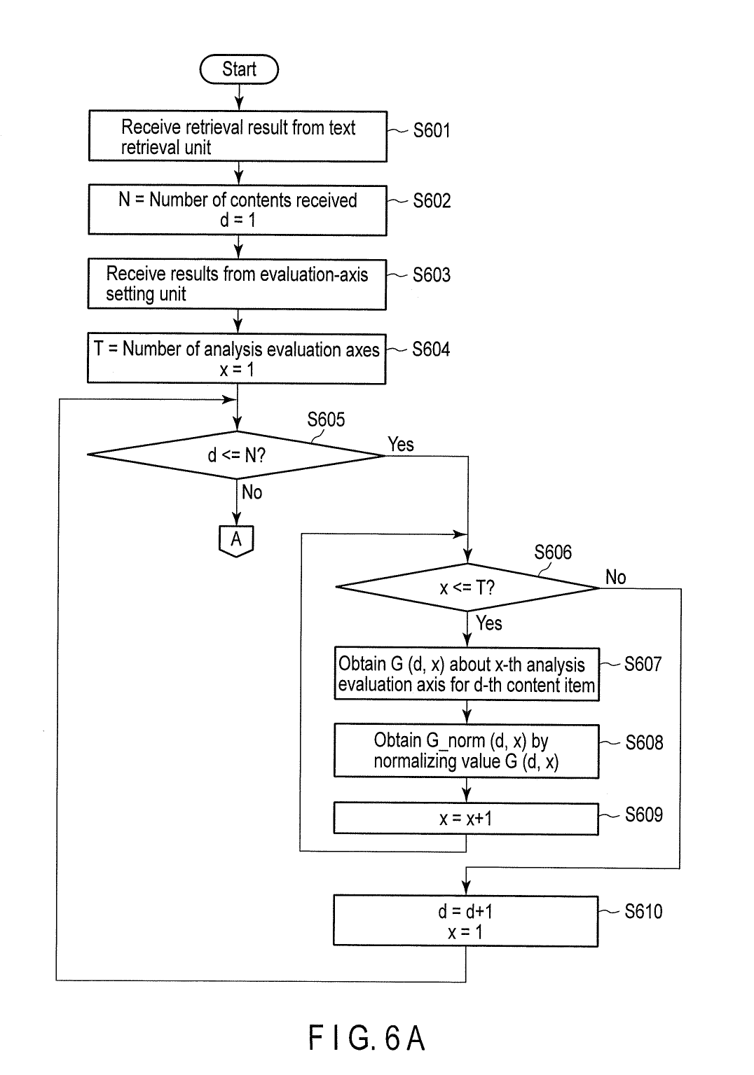

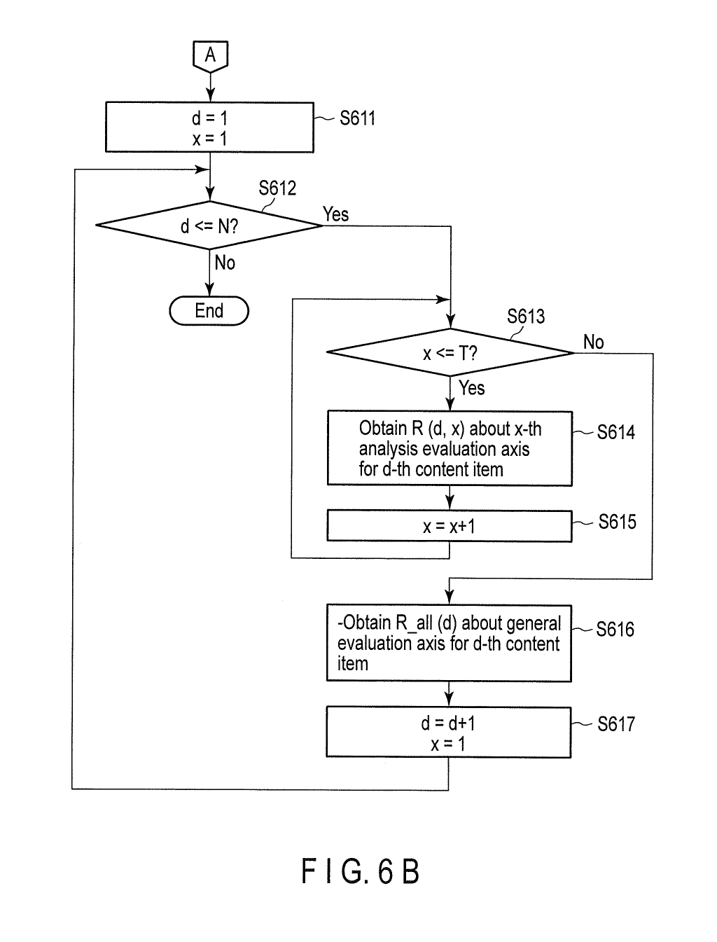

The analysis process of the result analysis unit 107 will be explained with reference to the flowchart of FIG. 6A and FIG. 6B.

In Step S601, the result analysis unit 107 receives a retrieval result (i.e., content) from the text retrieval unit 106.

In Step S602, the result analysis unit 107 sets the number of contents received as the retrieval result, to variable N, and sets the initial value 1 to a variable d.

In Step S603, the result analysis unit 107 receives general axes and the analysis evaluation axes from the evaluation-axis setting unit 105.

In Step S604, the result analysis unit 107 sets the number of analysis evaluation axes to variable T, and the initial value 1 to variable x.

In Step S605, the result analysis unit 107 determines whether or not variable d is not more than N. If variable d is not more than N, the process will go to Step S606. If variable d is greater than N, the process goes to Operation A (shown in FIG. 6B).

In Step S606, the result analysis unit 107 determines whether or not variable x is not more than T. If variable x is not more than T, the process goes to Step S607. If variable x is greater than T, the process goes to Step S610.

In Step S607, value G (d, x) about the x-th analysis evaluation axis is obtained for the d-th content item.

In Step S608, value G_norm (d, x) is obtained by normalizing the value G (d, x).

In Step S609, variable x is incremented by one. Then, the process returns to Step S606, which is repeated.

In Step S610, variable d is incremented by one, and the initial value 1 is set to variable x. Then, the process returns to Step S605, which is repeated.

Assume that the process goes from Step S605 to Operation A. Then, in Step S611, the initial value 1 is set to variable d, and also to variable x.

In Step S612, the result analysis unit 107 determines whether or not variable d is not more than N. If variable d is not more than N, the process will go to Step S613. If variable d is greater than N, the result analysis unit 107 terminates the analysis.

In Step S613, the result analysis unit 107 determines whether or not variable x is not more than T. If variable x is not more than T, the process goes to Step S614. If variable x is greater than T, the process goes to Step S616.

In Step S614, the result analysis unit 107 obtains an analysis value R (d, x) about the x-th analysis evaluation axis for the d-th content item.

In Step S615, variable x is incremented by one. Then, the process returns to Step S613, which is repeated.

In Step S616, an analysis value R_all (d) is obtained for the d-th content item.

In Step S617, variable d is incremented by one, and the initial value 1 is set to variable x. The process then returns to Step S612, which is repeated.

In Steps S614 and S616, the analysis value R (d, x) and the analysis value R_all (d), with respect to the general analysis evaluation axis and general evaluation axis, respectively, may be written in a buffer (for example, data storage unit) and may be stored therein.

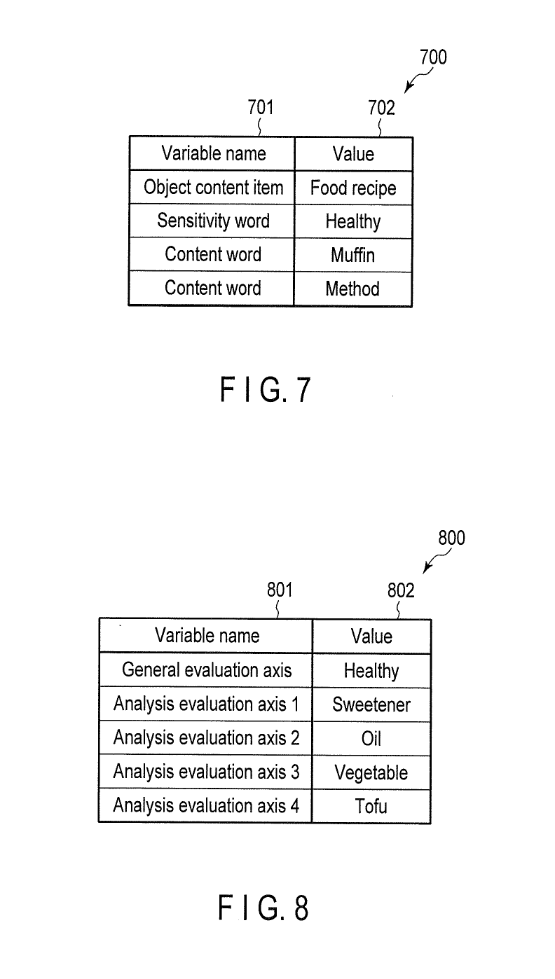

A specific example of an operation of the sensitivity retrieval apparatus according to this embodiment, and calculation method of the values G (d, x), G_norm (d, x), R (d, x) and R_all (d) will be explained, with reference to FIG. 7 to FIG. 11.

Assume that the user has input a retrieval request sentence of “Teach me a method of preparing a healthy muffin.”

Then, the request analysis unit 103 receives the retrieval request sentence, i.e., “Teach me a method of preparing a healthy muffin,” from the request receiving unit 102. The request analysis unit 103 performs morpheme analysis on the retrieval request sentence, acquiring a result of “teach/me/a/method/of preparing/healthy/muffin.”A symbol “/” is a partition of each morpheme.

The estimation rule of FIG. 3 shows that the word “method” is identical to the condition 302 “method.” Therefore, the content to retrieve is estimated to be “food recipe.” The request analysis unit 103 extracts “healthy” as sensitivity word, and the nouns “muffin” and “method” as content words.

A content item to retrieve, a sensitivity word and a content word, all acquired by the request analysis unit 103, may be stored in a buffer as shown in the table 700 of FIG. 7.

As seen from the table 700, variable names 701 and values 702 are stored, each variable name associated with one value. The table 700 includes a content item to retrieve, a sensitivity word and content words, each as variable name 701. The variable name 701, “content to retrieve,” for example, is stored in association with the value 702, “food recipe.”

Next, the evaluation-axis setting unit 105 receives the sensitivity word “healthy” from the request analysis unit 103. The evaluation-axis setting unit 105 then determines whether or not the sensitivity word “healthy” is identical to any word included in the sensitivity-expression synonym set 502 stored in the expression storage 104 of FIG. 5. The sensitivity word “healthy” is identical to the word “healthy” included in the sensitivity-expression synonym set 502, and the word “healthy” is therefore set on the general evaluation axis. Further, four content representative words 504, “sweetener,” “oil,” “vegetable” and “tofu,” which are associated with the word “healthy,” are set on the analysis evaluation axis.

FIG. 8 shows an example of a table including the general evaluation axis and analysis evaluation axes the evaluation-axis setting unit 105 has acquired.

The table 800 shown in FIG. 8 stores variable names 801 and values 802, each variable name associated with one value. The variable name 801 “general evaluation axis,” for example, is associated with the value 802 “healthy” in the table 800.

Then, the text retrieval unit 106 receives the content words “muffin” and “method,” both shown in FIG. 7, from the request analysis unit 103. Using these content words, “muffin” and “method,” the text retrieval unit 106 retrieves the food recipe (i.e., content that should be retrieved) from the food recipe database 121 in the storage apparatus 120.

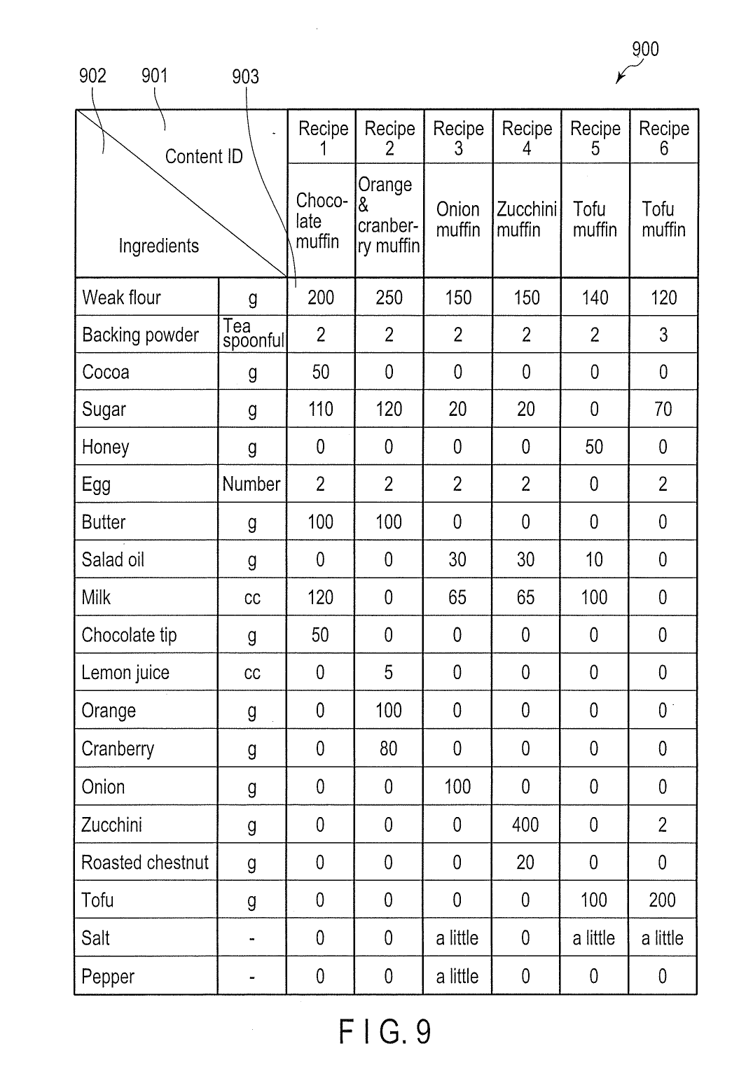

FIG. 9 shows an example of a table holding the retrieval result obtained in the text retrieval unit 106.

The table 900 of FIG. 9 holds the content IDs 901, ingredients 902 of the content, and the amounts 903 in which the ingredients 902 are used in the content.

Each content ID 901 is a unique identifier identifying a content item retrieved by the text retrieval unit 106. Each ingredient 902 represents a material of the food identified by a content ID, and is associated with the quantity unit of the material. Each amount 903 represents the amount in which a material should be used and which has been extracted from the content.

Content ID 901, “recipe 1, chocolate muffin,” for example, is associated with ingredient 902, “weak flour g (gram)” used in amount 903 of “200,” another ingredient 902, “baking powder, tea-spoonful” used in amount 903 of “2.”

Next, the result analysis unit 107 acquires a value G (d, x) with respect to each analysis evaluation axis.

From the data stored in the buffers shown in FIG. 7 and FIG. 8, an expression (material) registered in the content representative words or in the content-related word set may be extracted for the content (i.e., recipe) and each analysis evaluation axis. In this case, the amount will be calculated, in which the expression (material) should be used. In the example of FIG. 9, the total amount of “sugar” and “honey” is calculated as the value for “sweetener.” Similarly, the total amount of “butter” and “salad oil” is calculated as the value for “oil,” the total amount of “onion” and “zucchini” is calculated for “vegetable,” and the amount of “tofu” is calculated as the value for “tofu.”

Thus, value G (d, x) is acquired with respect to d={receipt 1, recipe 2, recipe 3, recipe 4, recipe 5, recipe 6} and x={sweetener, oil, vegetable, tofu}.

Then, value G_norm (d, x), i.e., normalized G (d, x), is calculated.

The content items available on the ordinary web differ, each from another, in amount depending on for how many persons the food is prepared. In view of this, the amount should be normalized. If the content specifies the number of persons, the amount may be normalized to the value for one person or one portion. Assume here that the amount for every 100 g of weak flour, i.e., main material, is used as G_norm (d, x).

Next, G_norm (d, x) is normalized, changing the average to zero and the standard deviation to 1, whereby analysis value R (d, x) is obtained. R (d, x) may be calculated, using the following equation (1):

R(d,x)=(G_norm(d,x)−avr(x))/stdev(x) (1)

where avr (x) is the average of G_norm (d, x), and stdev (x) is the standard deviation.

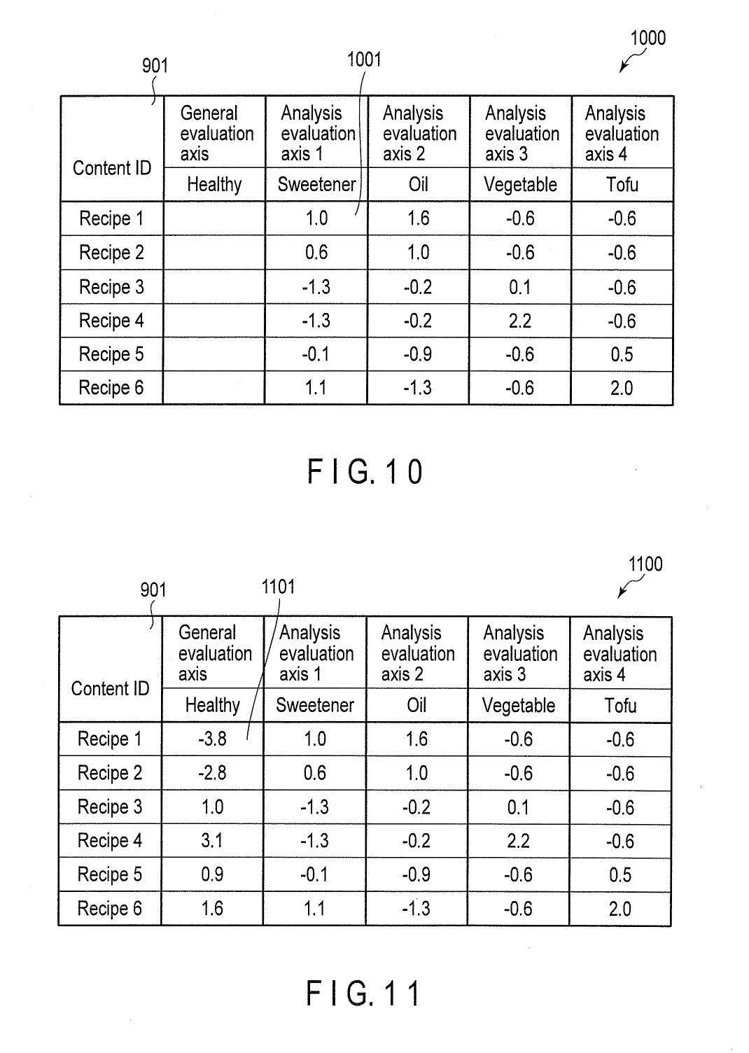

FIG. 10 shows an example of a table storing the values of R (d, x) calculated by using the equation (1).

The table 1000 shown in FIG. 10 holds analysis values 1001, each for a combination of one content ID 901 and four analysis evaluation axes 1 to 4. That is, for each recipe identified with a content ID 901, the analysis values of four analysis evaluation axes (sweetener, oil, vegetable and tofu) are held in the table 1000. In the content ID 901, “recipe 1,” for example, the analysis value 1001 for “sweetener” (i.e., “analysis evaluation axis 1”) is “1.9,” and the analysis value 1001 for “oil” (i.e., analysis evaluation axis 2) is “1.6.”

Further, the analysis value R_all (d) for the general evaluation axis is calculated. The analysis value R_all (d) for the general evaluation axis can be calculated by adding the values of all analysis evaluation axes, considering the evaluation polarities shown in FIG. 5, as may be seen from the following equation (2):

R_all(d)=ΣR(d,x)×P(x) (2)

where P (x)={1, if the evaluation polarity of x is positive},
{−1, if the evaluation polarity of x is negative}.

The analysis value R_all (d) calculated may be stored in a buffer as shown in FIG. 11.

In the table 1100 of FIG. 11, the analysis value R_all (d) for the general evaluation axis (healthy) is associated with each recipe, in addition to the analysis value R (d, x) for the general evaluation axis (healthy). More specifically, the analysis values of the analysis axes (sweetener, oil, vegetable and tofu) are added in accordance with their polarities, namely −1.0+(−1.6)+(−0.6)+(−0.6)=−3.8. Analysis value 1101, R_all (d), is thereby obtained.

This analysis value is obtained by using the average of normalized data items and the standard deviation thereof. Instead, the analysis value can be calculated by any other method available.

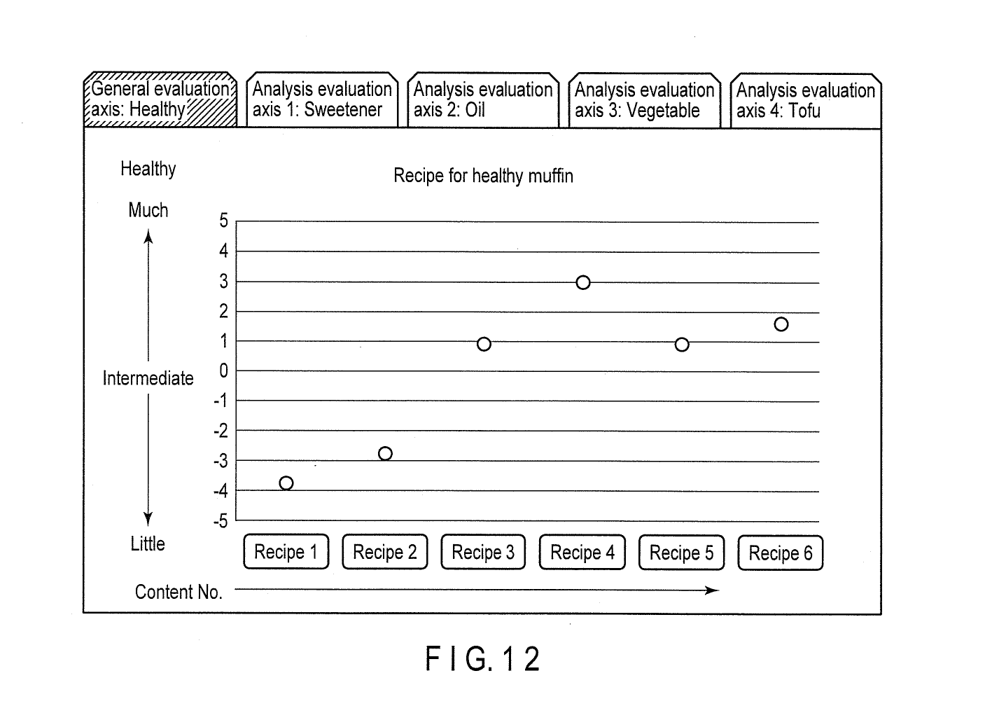

Several examples of the analysis result the result presentation unit 108 may display will be described with reference to FIG. 12 to FIG. 17.

FIG. 12 to FIG. 17 show various results obtained in retrieving “the method of preparing a healthy muffin” described above.

FIG. 12 shows the retrieval result that the result for the general evaluation axis “healthy.” In FIG. 12, content numbers are plotted on the horizontal axis, and the analysis values of “healthy” on the general evaluation axis are plotted on the vertical axis. In the retrieval result of FIG. 12, the analysis value ranges from 5 to −5. The greater the value, the higher the “healthy” level will be, and the smaller the value, the lower the “healthy” level will be. As seen from FIG. 12, the recipe 4 is analyzed to be most healthy, as a whole.

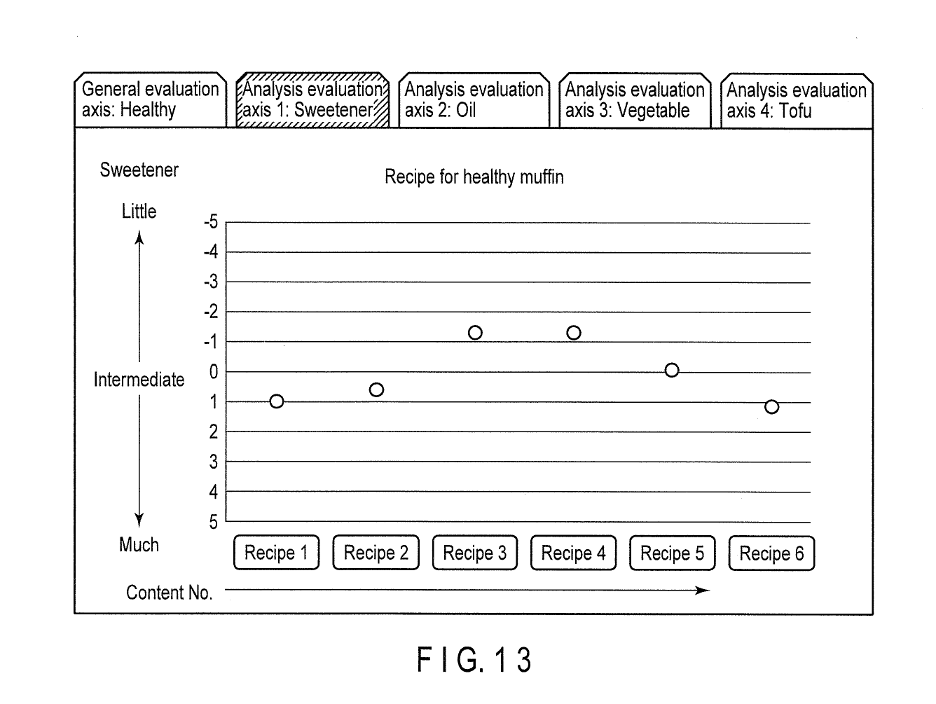

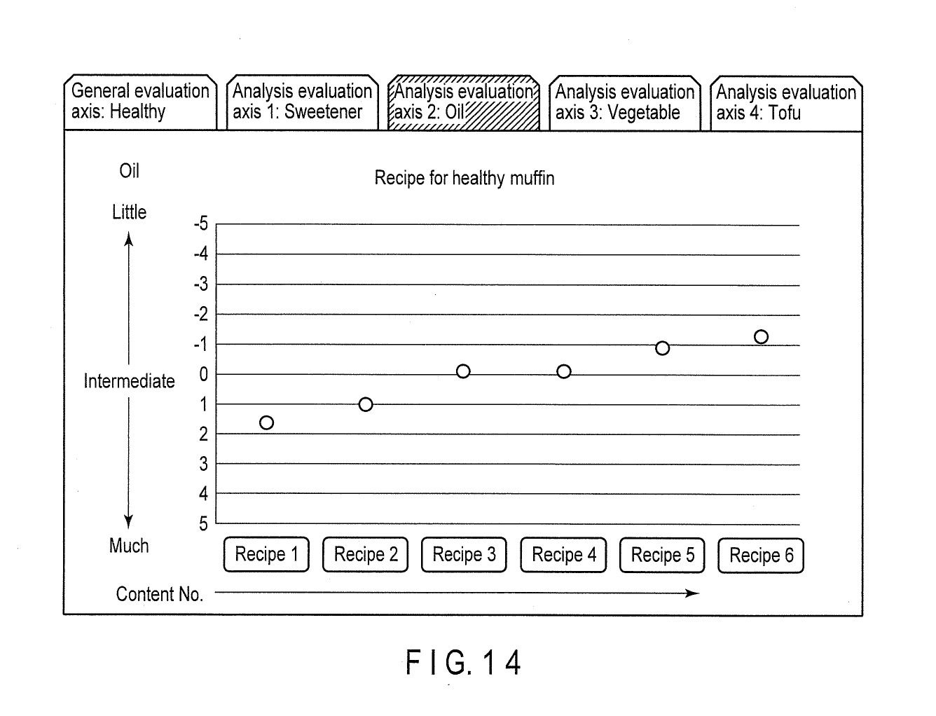

FIG. 13 shows a display screen displaying the retrieval result for the analysis evaluation axis “sweetener.” The retrieval result shown in FIG. 12, for example, may be switched to any one of the retrieval results shown in FIG. 14 to FIG. 16, by selecting one of the tubs for the respective analysis evaluation axes.

Since “sweetener” has negative polarity with respect to the general evaluation axis “healthy,” the axis for “sweetener” is inverse to the axis shown in FIG. 12. That is, the smaller the value, the higher the “healthy” level will be, and the greater the value, the lower the “healthy” level will be. Therefore, the recipes 3 and 4 have comparatively high “healthy” levels in respect of sweetener.

FIG. 14 shows a display screen displaying the retrieval result for the analysis evaluation axis “oil.” As in the retrieval result of FIG. 13, the analysis evaluation axis “oil” has negative polarity with respect to the general evaluation axis “healthy.” The analysis evaluation “oil” is thus inverse to the axis shown in FIG. 12. Therefore, the recipes 5 and 6 have high “healthy” levels in respect of oil.

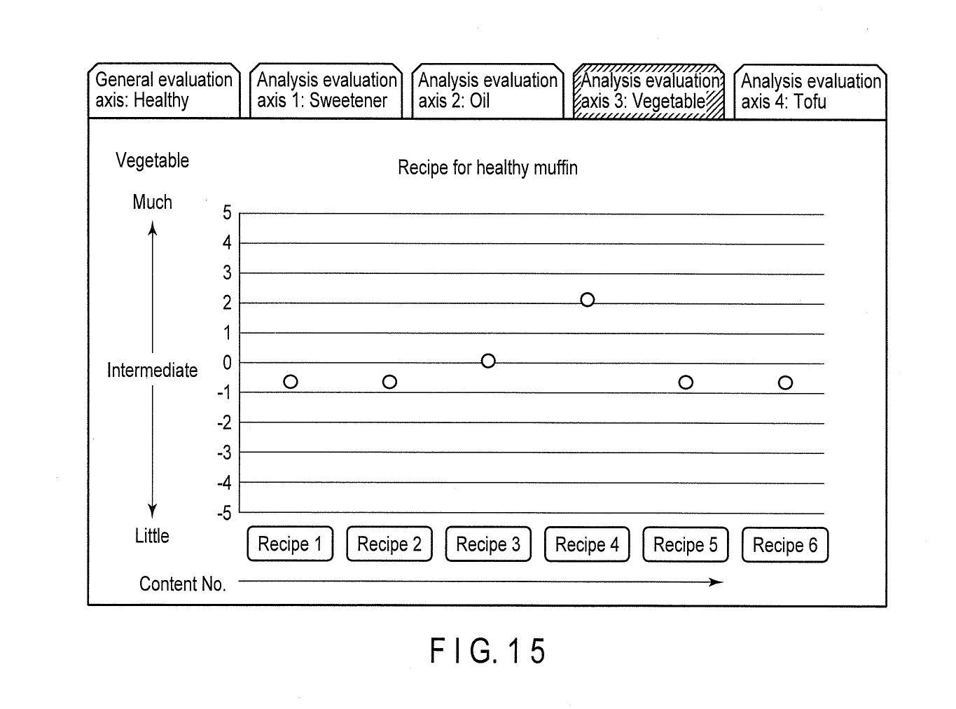

FIG. 15 shows a display screen displaying the retrieval result for the analysis evaluation axis “vegetable.” Generally speaking, the more vegetable used, the healthier the food will be. The analysis evaluation axis “vegetable” therefore has the same polarity as the general evaluation axis “healthy.” That is, the greater the value of the analysis evaluation axis “vegetable,” the healthier the food will be, and the smaller the value of the analysis evaluation axis “vegetable,” the less healthy the food will be. In respect of vegetable, the recipe 4 has a high “healthy” level as seen from FIG. 15.

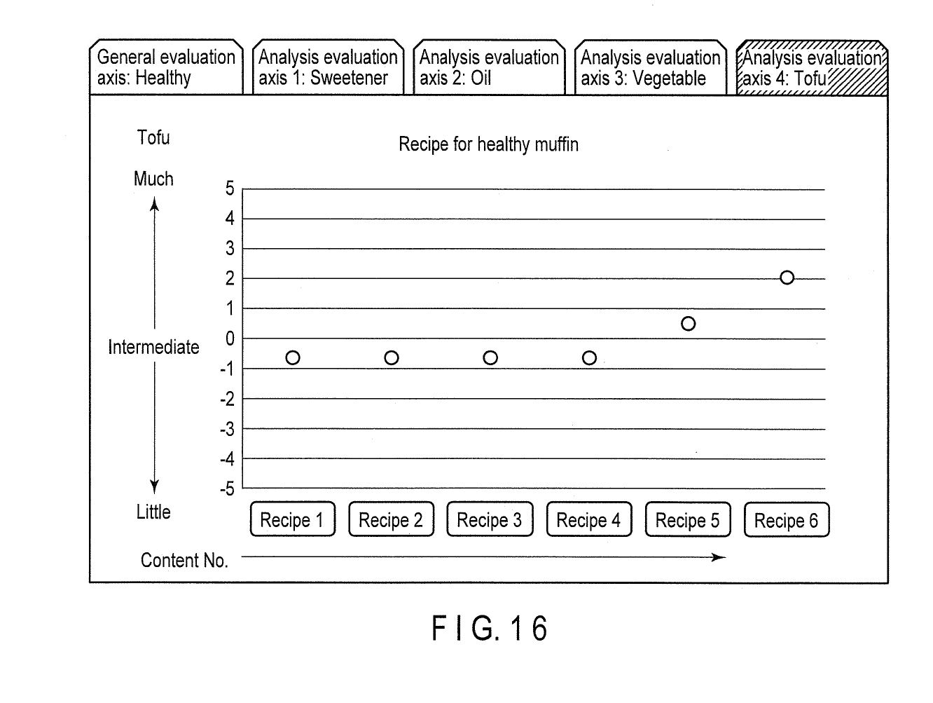

FIG. 16 shows a display screen displaying the retrieval result for the analysis evaluation axis “tofu.” Generally, the more tofu used, the healthier the food will be, as in the case of vegetable. The analysis evaluation axis “tofu” therefore has the same polarity as the general evaluation axis “healthy.” That is, the greater the value of the analysis evaluation axis “tofu,” the healthier the food will be, and the smaller the value of the analysis evaluation axis “tofu,” the less healthy the food will be. In respect of tofu, the recipe 6 has a high “healthy” level as seen from FIG. 16.

The sensitivity retrieval apparatus may be so designed that a recipe introducing screen will be displayed if the user clicks the ID of any document in order to know much about the document.

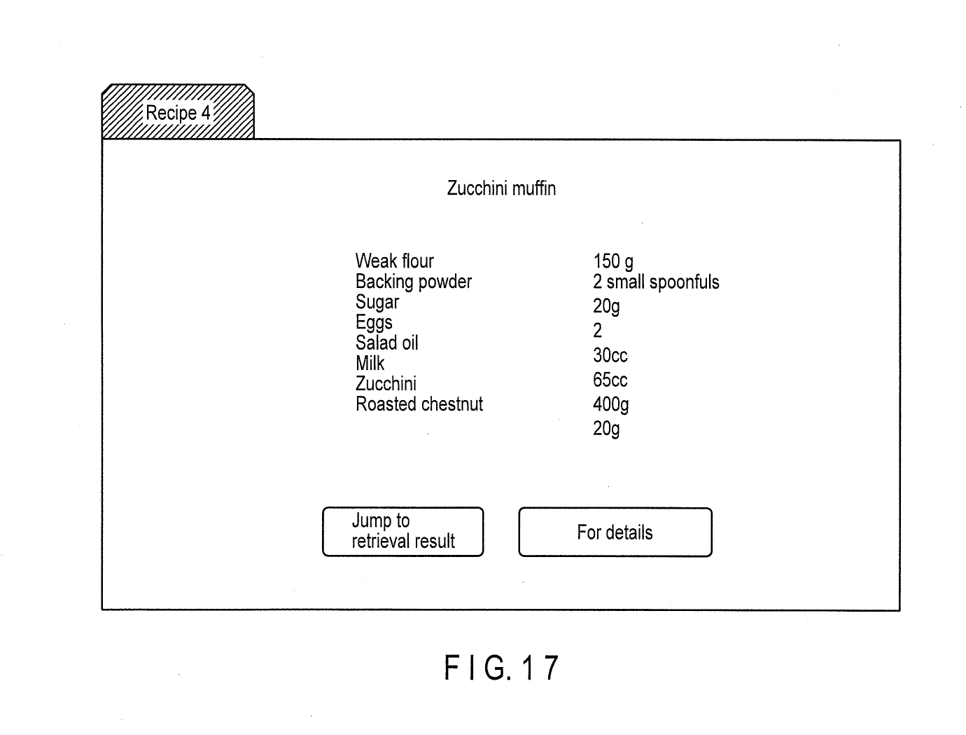

FIG. 17 shows an example of the recipe introducing screen, which displays recipe 4, i.e. “method of preparing zucchini muffin.”

Assume that the user clicks the “Jump to the retrieval result table” button on the recipe introducing screen. Then, the screen is switched back to such a display screen as shown in FIG. 12. Alternatively, the user may click the “For details of the method” button on the recipe introducing screen. In this case, the sequence of preparing zucchini muffin” is displayed. The tab selection (clicking) and the button selection (clicking) are not limited to the case explained with reference to FIG. 17. Rather, the sequence of preparing the food may be displayed when the document ID is clicked.

The analysis result for each evaluation axis is thus presented to the user. This makes it easy for the user to know how to change the recipe quite he or she has never tried, in order to adjust the food to his or her taste.

Since a plurality of evaluation axes are set for any keyword input as retrieval request sentence, various content items can be selected in accordance with different evaluation axes. In the example specified above, for example, the user may input “healthy” as retrieval request sentence, thereby acquiring various recipes of foods considered healthy. In this case, the user may then select a recipe having a small analysis value of “oil.” If the user thinks it healthy to each much vegetable, he or she may select a recipe having a large analysis value of “vegetable.” Thus, the sensitivity expression of “healthy” can be replaced with a more specific or objective expression that shows the basis of healthiness. The user can therefore select a recipe more agreeable to his taste.

The content selected in the example described above is a recipe. Nonetheless, to select any other type of content, a process similar to the process explained above may be performed.

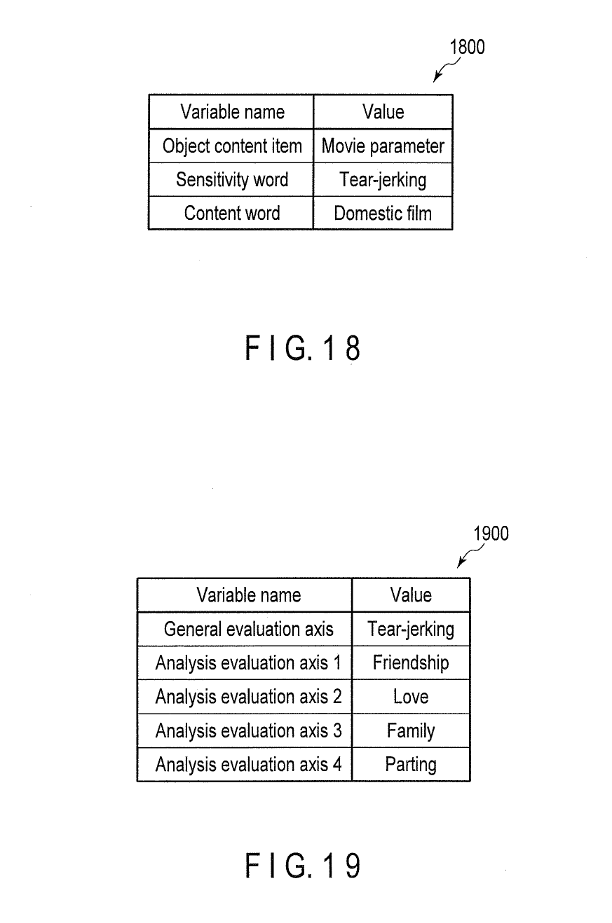

For example, the user may input “tear-jerking movies” as retrieval request sentence. In this case, the process proceeds as will be explained with reference to FIG. 18 to FIG. 20.

FIG. 18 shows a table 1800 generated as the request analysis unit 103 analyzes the retrieval request sentence. As shown in FIG. 18, “movie metadata” is extracted as content to retrieve, “tear-jerking” is extracted as a sensitivity word, and “domestic film” is extracted as a content word.

FIG. 19 shows a table 1900 generated as the evaluation-axis setting unit 105 extracted a general evaluation axis and analysis evaluation axes. The sensitivity word “tear-jerking” is set as general evaluation axis. Hence, “friendship,” “love,” “family” and “parting,” all shown in FIG. 5, are set as analysis evaluation axes. The content for each analysis evaluation axis is retrieved, in respect of the associated content word.

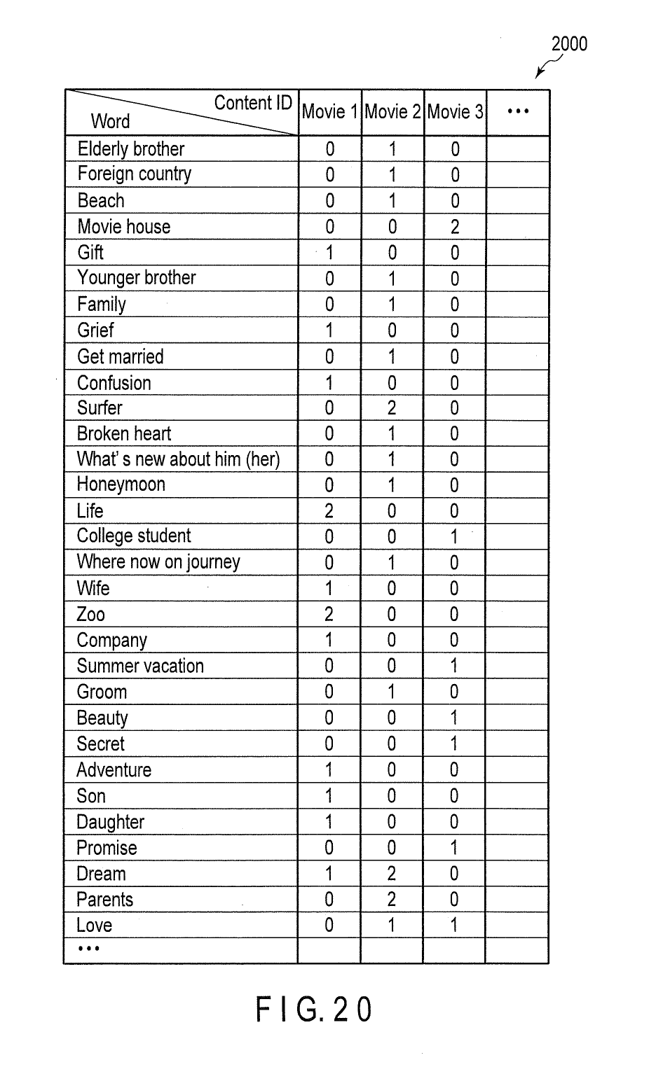

FIG. 20 shows a table 2000 of the retrieval results acquired in the text retrieval unit 106. In the retrieval process, it is determine whether each movie metadata item about the movie content to retrieve accords with any content representative word (FIG. 5) or with any sensitivity-expression synonym set (FIG. 5). If the movie metadata item is found to accord with a content representative word or a sensitivity-expression synonym set, the total use frequency of these movie metadata items.

The content texts included in the metadata differ in length form one another. The value G (d, x) is therefore normalized, obtaining G_norm (d, x) by using the following equation (3):

G_norm(d,x)=G(d,x)/C(d) (3)

where C (d) is the number of words appearing in content item d. Note that both the analysis value G (d, x) and the analysis value R_all (d) have been calculated by the methods described above. Therefore, it is not explained here how they are calculated.

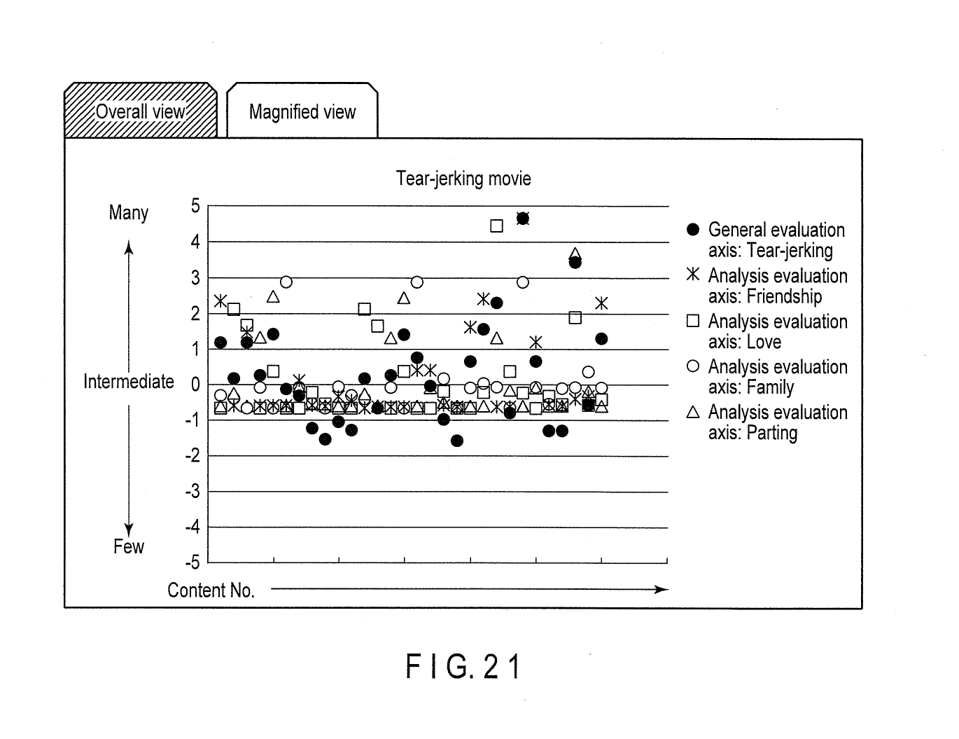

It will be explained how the result of retrieval performed in accordance with the retrieval request sentence of “tear-jerking movies” is displayed, with reference to FIG. 21 to FIG. 25.

FIG. 21 is a diagram showing the result of retrieving “tear-jerking movies.” Plotted on the vertical axis are evaluated values on the general evaluation axis and the analysis evaluation axes. Plotted on the horizontal axis are content numbers, more precisely movie IDs.

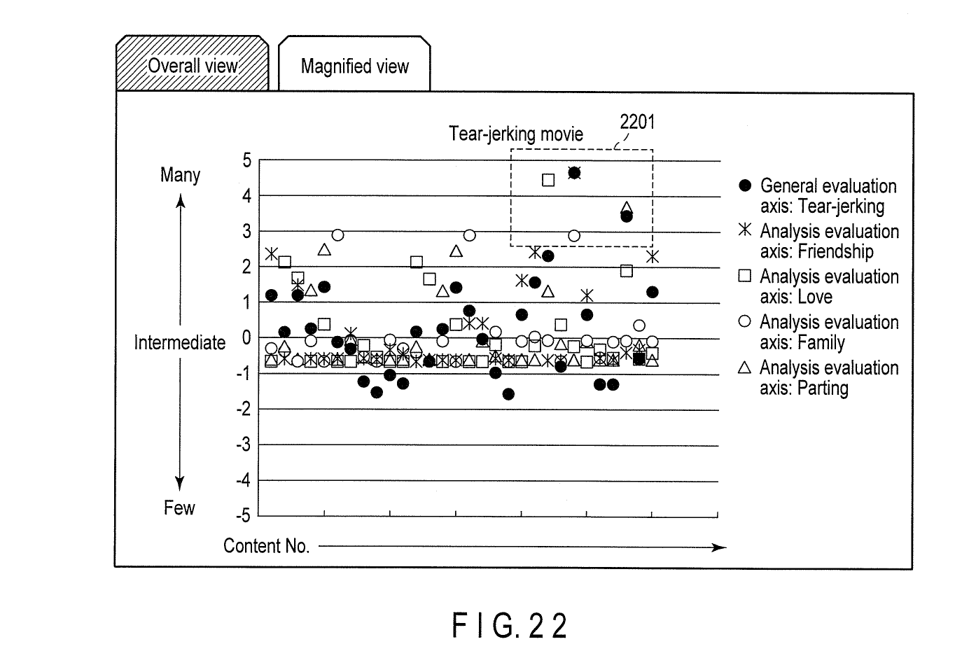

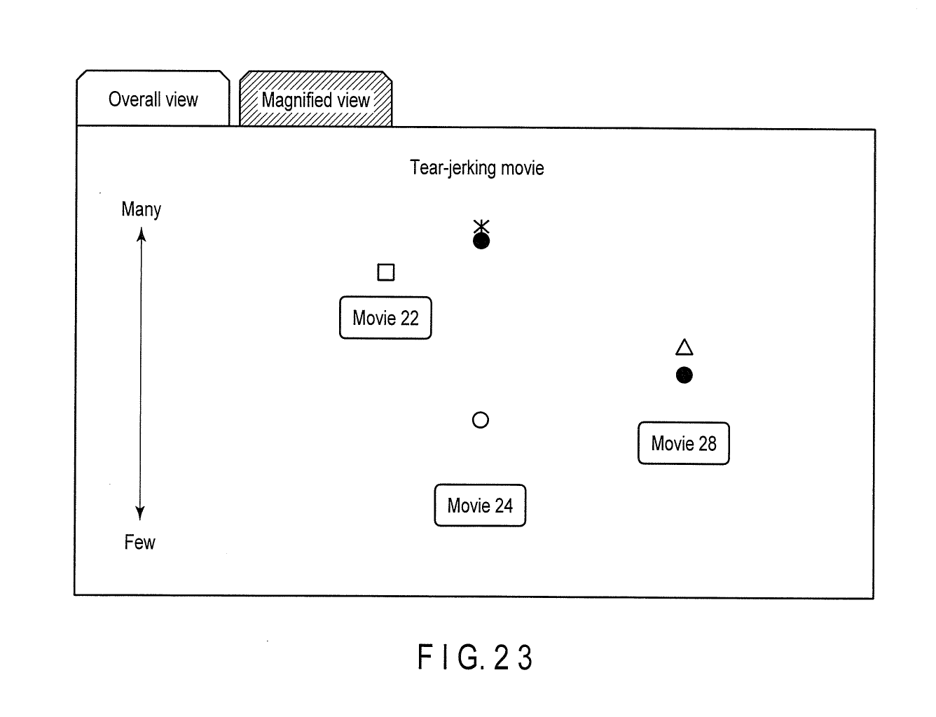

To inspect a region in detail, the user clicks such a region 2201 of the display screen, shown in FIG. 22, thereby magnifying the region 2201. FIG. 23 shows this region 2201 so magnified. As shown in FIG. 23, movie IDs may be displayed near the analyzed values, respectively.

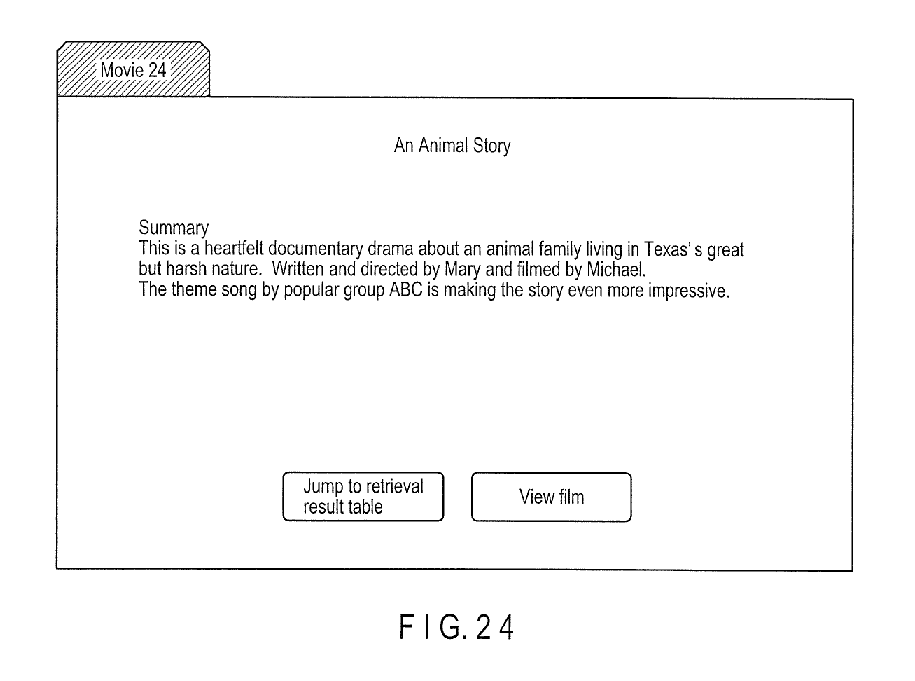

FIG. 24 shows another analysis result displayed in a magnified form if the user clicks the ID of the movie he or she wants to see. More precisely, FIG. 24 shows a brief guide sentence of movie ID 24, “An Animal Story.” The user may click the “Jump to the retrieval result table” button on the recipe introducing screen and then click the “View the film” button, as in the case described with reference to FIG. 17. Then, the user can enjoy viewing the movie selected.

The method of displaying data, explained with reference to FIGS. 21 to 24, is useful if many content items have been retrieved. The content retrieved may be displayed in another method.

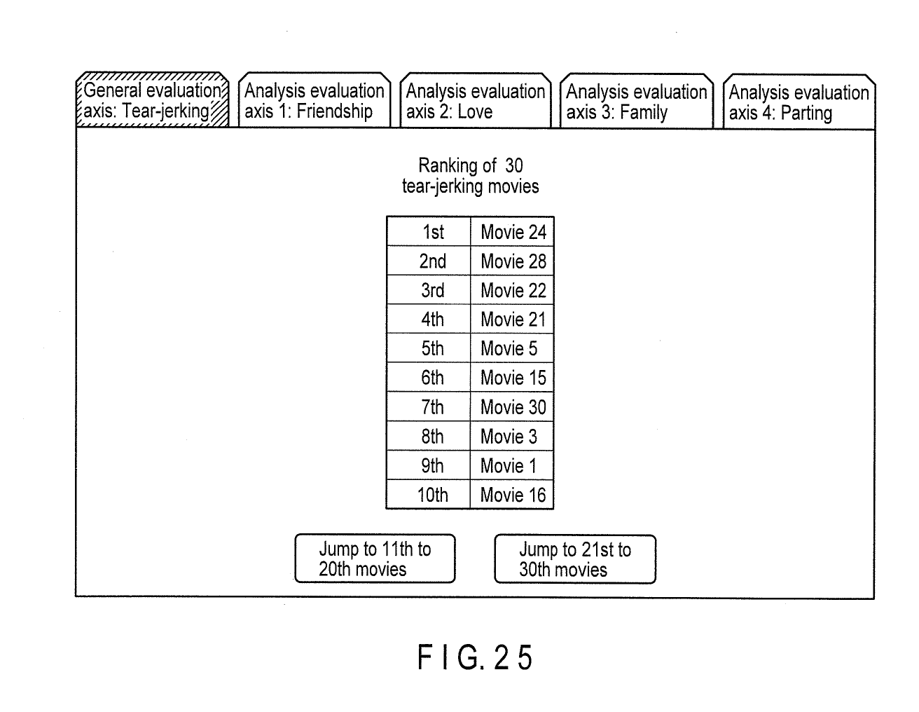

FIG. 25 shows a method of displaying the retrieved content in the form of a list 2501. As seen from FIG. 25, the list 2501 is a ranking list in which the movies retrieved for any evaluation axis are ranked. This display method is useful in the case where the user operates a remote controller to select any movie shown in the list 2501 displayed.

In the embodiment described above, an evaluation axis is set for any content to retrieve, in accordance with the retrieval request sentence including a sensitivity expression, and an analysis value is calculated for the evaluation axis of the content. The content can therefore be easily evaluated with respect to the evaluation axis. Hence, content agreeable to the user's taste can be efficiently retrieved, not influenced by the reputation available in word-of-mouth communication information.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A sensitivity retrieval apparatus comprising:
a storage configured to store sensitivity expressions which are words representing sensitivity;
a receiving unit configured to receive a retrieval request sentence which is a character string to retrieve;
a setting unit configured to set an evaluation axis for a sensitivity word if the sensitivity word which is a part of the sensitivity expressions and which is included in the retrieval request sentence;
a retrieval unit configured to perform retrieval based on the retrieval request sentence, to obtain a plurality of requested content items;
an analysis unit configured to calculate analysis values for the requested content items based on the evaluation axis; and
a presentation unit configured to present at least one requested content item based on the analysis values.

2. The apparatus according to claim 1, wherein
the storage stores one of the sensitivity expressions, at least one content expression and an evaluation polarity in association with each other, the at least one content expression representing an element of the sensitivity expression, the evaluation polarity representing a relationship between the sensitivity expression and the content expression; and
the presentation unit determines a direction for the analysis values with respect to the evaluation axis and presents the analysis values, by arranging the analysis values in a two-dimensional coordinate plane defined by two axes on which content numbers and the analysis values are plotted, respectively.

3. The apparatus according to claim 2, wherein the presentation unit determines a direction for the analysis values with respect to the evaluation axis based on the evaluation polarity, and presents the analysis values in either an ascending order or descending order in the direction of the evaluation axes.

4. The apparatus according to claim 1, wherein
the storage stores one of the sensitivity expressions, at least one content expression and an evaluation polarity in association with each other, the at least one content expression representing an element of the sensitivity expression, the evaluation polarity representing a relationship between the sensitivity expression and the content expression;
the setting unit sets the sensitivity word as a general evaluation axis and sets at least one content expression associated with the sensitivity expression identical to the sensitivity word, as one or more analysis evaluation axes; and
the analysis unit calculates a first analysis value for the requested content items, with respect to each of the analysis evaluation axes, and a second analysis value for the requested content items based on the first analysis value, with respect to the general evaluation axis, and obtains analysis results from a plurality of first analysis values and the second analysis value.

5. The apparatus according to claim 4, wherein the presentation unit determines directions for the first analysis values and the second analysis value, respectively, with respect to the analysis evaluation axes and the general evaluation axis, based on the corresponding evaluation polarity, and presents the first analysis values and the second analysis value by arranging the first analysis values and the second analysis value in a two-dimensional coordinate plane defined by two axes on which content numbers and the first analysis values and the second analysis value are plotted, respectively.

6. The apparatus according to claim 4, wherein the presentation unit determines directions for the first analysis values and the second analysis value, respectively, with respect to the analysis evaluation axes and the general evaluation axis based on the corresponding evaluation polarity, and presents the first analysis values and the second analysis value in either an ascending order or descending order in the direction of the analysis evaluation axes and the general evaluation axis.

7. The apparatus according to claim 1, wherein the retrieval unit performs retrieval in accordance with a content word that is a noun and other than the sensitivity word included in the retrieval request sentence.

8. A sensitivity retrieval method comprising:
storing, in a storage, sensitivity expressions which are words representing sensitivity;
receiving a retrieval request sentence which is a character string to retrieve;
setting an evaluation axis for a sensitivity word if the sensitivity word which is a part of the sensitivity expressions and which is included in the retrieval request sentence;
performing retrieval based on the retrieval request sentence, to obtain a plurality of requested content items;
calculating analysis values for the requested content items based on the evaluation axis; and
presenting at least one requested content item based on the analysis values.

9. The method according to claim 8, wherein
the storing the sensitivity expressions stores one of the sensitivity expressions, at least one content expression and an evaluation polarity in association with each other, the at least one content expression representing an element of the sensitivity expression, the evaluation polarity representing a relationship between the sensitivity expression and the content expression; and
the presenting the at least one requested content item determines a direction for the analysis values with respect to the evaluation axis and presents the analysis values, by arranging the analysis values in a two-dimensional coordinate plane defined by two axes on which content numbers and the analysis values are plotted, respectively.

10. The method according to claim 9, wherein the presenting the at least one requested content item determines a direction for the analysis values with respect to the evaluation axis based on the evaluation polarity, and presents the analysis values in either an ascending order or descending order in the direction of the evaluation axes.

11. The method according to claim 8, wherein
the storing the sensitivity expressions stores one of the sensitivity expressions, at least one content expression and an evaluation polarity in association with each other, the at least one content expression representing an element of the sensitivity expression, the evaluation polarity representing a relationship between the sensitivity expression and the content expression;
the setting the evaluation axis sets the sensitivity word as a general evaluation axis and sets at least one content expression associated with the sensitivity expression identical to the sensitivity word, as one or more analysis evaluation axes; and
the calculating the analysis values calculates a first analysis value for the requested content items, with respect to each of the analysis evaluation axes, and a second analysis value for the requested content items based on the first analysis value, with respect to the general evaluation axis, and obtains analysis results from a plurality of first analysis values and the second analysis value.

12. The method according to claim 11, wherein the presenting the at least one requested content item determines directions for the first analysis values and the second analysis value, respectively, with respect to the analysis evaluation axes and the general evaluation axis, based on the corresponding evaluation polarity, and presents the first analysis values and the second analysis value by arranging the first analysis values and the second analysis value in a two-dimensional coordinate plane defined by two axes on which content numbers and the first analysis values and the second analysis value are plotted, respectively.

13. The method according to claim 11, wherein the presenting the at least one requested content item determines directions for the first analysis values and the second analysis value, respectively, with respect to the analysis evaluation axes and the general evaluation axis based on the corresponding evaluation polarity, and presents the first analysis values and the second analysis value in either an ascending order or descending order in the direction of the analysis evaluation axes and the general evaluation axis.

14. The apparatus according to claim 8, wherein the performing retrieval performs retrieval in accordance with a content word that is a noun and other than the sensitivity word included in the retrieval request sentence.

15. A non-transitory computer readable medium including computer executable instructions, wherein the instructions, when executed by a processor, cause the processor to perform a method comprising:
storing, in a storage, sensitivity expressions which are words representing sensitivity;
receiving a retrieval request sentence which is a character string to retrieve;
setting an evaluation axis for a sensitivity word if the sensitivity word which is a part of the sensitivity expressions and which is included in the retrieval request sentence;
performing retrieval based on the retrieval request sentence, to obtain a plurality of requested content items;
calculating analysis values for the requested content items based on the evaluation axis; and
presenting at least one requested content item based on the analysis values.

16. The medium according to claim 15, wherein
the storing the sensitivity expressions stores one of the sensitivity expressions, at least one content expression and an evaluation polarity in association with each other, the at least one content expression representing an element of the sensitivity expression, the evaluation polarity representing a relationship between the sensitivity expression and the content expression; and
the presenting the at least one requested content item determines a direction for the analysis values with respect to the evaluation axis and presents the analysis values, by arranging the analysis values in a two-dimensional coordinate plane defined by two axes on which content numbers and the analysis values are plotted, respectively.

17. The medium according to claim 16, wherein the presenting the at least one requested content item determines a direction for the analysis values with respect to the evaluation axis based on the evaluation polarity, and presents the analysis values in either an ascending order or descending order in the direction of the evaluation axes.

18. The medium according to claim 15, wherein
the storing the sensitivity expressions stores one of the sensitivity expressions, at least one content expression and an evaluation polarity in association with each other, the at least one content expression representing an element of the sensitivity expression, the evaluation polarity representing a relationship between the sensitivity expression and the content expression;
the setting the evaluation axis sets the sensitivity word as a general evaluation axis and sets at least one content expression associated with the sensitivity expression identical to the sensitivity word, as one or more analysis evaluation axes; and
the calculating the analysis values calculates a first analysis value for the requested content items, with respect to each of the analysis evaluation axes, and a second analysis value for the requested content items based on the first analysis value, with respect to the general evaluation axis, and obtains analysis results from a plurality of first analysis values and the second analysis value.

19. The medium according to claim 15, wherein the presenting the at least one requested content item determines directions for the first analysis values and the second analysis value, respectively, with respect to the analysis evaluation axes and the general evaluation axis, based on the corresponding evaluation polarity, and presents the first analysis values and the second analysis value by arranging the first analysis values and the second analysis value in a two-dimensional coordinate plane defined by two axes on which content numbers and the first analysis values and the second analysis value are plotted, respectively.

20. The medium according to claim 15, wherein the presenting the at least one requested content item determines directions for the first analysis values and the second analysis value, respectively, with respect to the analysis evaluation axes and the general evaluation axis based on the corresponding evaluation polarity, and presents the first analysis values and the second analysis value in either an ascending order or descending order in the direction of the analysis evaluation axes and the general evaluation axis.
